(19) United States
(12) Patent Application Publication
(10) Pub. No.: US 2006/0110674 A1
(43) Pub. Date: May 25, 2006

(54) Method of producing polyester, method of producing electrostatic developing toner and electrostatic developing toner

(75) Inventors: Hideo Maehata, Minamiashigara-shi (JP); Yasuo Yamamoto, Minamiashigara-shi (JP); Satoshi Hiraoka, Minamiashigara-shi (JP); Yasuo Matsumura, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/115,206

(22) Filed: Apr. 27, 2005

(30) Foreign Application Priority Data
Nov. 22, 2004 (JP) 2004-337253

(51) Int. Cl. G03G 9/087

(52) U.S. Cl. 430/109.3; 430/109.4; 528/272

(57) ABSTRACT

In the method of the present invention, a polyester is produced by a step of emulsifying or dispersing a polyvalent acid component having a hydrophobic parameter (Log(P)) of −0.5 or more and 20 or less, a polyhydric alcohol component having a hydrophobic parameter (Log(P)) of −0.5 or more and 20 or less, and a hydrophobic material having a hydrophobic parameter (Log(P)) of −0.5 or more and 20 or less in an aqueous medium and then polycondensing the polyvalent acid component with the polyhydric alcohol component in the presence of the hydrophobic material. The polyester resin microparticles are then applied to an emulsion polymerization coagulation method to produce a toner.

### CROSS-REFERENCE TO RELATED APPLICATION

This application claims priority under 35 USC 119 from Japanese Patent Application No. 2004-337253, the disclosure of which is incorporated by reference herein.

### BACKGROUND OF THE INVENTION

1. Field of the Invention

The present invention relates to a method of producing a polyester utilized for the constituent material of an electrostatic developing toner (hereinafter referred to also as an electrophotographic toner) and to a method of producing an electrostatic developing toner utilizing the polyester. Also, the invention relates to an electrostatic developing toner obtained by utilizing these production methods.

2. Description of the Related Art

As part of a recent world-wide trend toward energy saving, society has increasingly come to demand answers to how to enable the supply of production methods and products reduced in energy consumption and environmental burden in industrial fields. In these circumstances, technical development is actively progressing, including, for example, reduction in fixing energy, previously having large energy consumption, in an electrophotographic process by using low-temperature fixing techniques using a polycondensation resin having a polyester structure as a toner resin.

Also, in a method of producing this polyester resin, polymerization and production techniques using low energy (low temperature) are demanded as this resin is currently produced by a polycondensation reaction at temperatures higher than 150° C. In this case, it has been recently found that, regarding the polymerization techniques of the polyester resin at lower temperatures, polymerization can be conducted at temperatures lower than 100° C. by using a polymerization catalyst comprising a rare earth element such as scandium (Macromolecules, 2003, 36, 1772-1774).

Intensive study is being made of, for example, the catalytic chemistry, mechanisms, and side-reactions, and the effects of residual catalysts, with respect to polyester resin polymerized using these novel polymerization catalysts. However, these studies have not progressed beyond the elementary technical research stage. Important challenges facing industry concern whether it is possible to put these to industrial use, and what differences exist with resins obtained by conventional processes, and what properties might be controlled, in order to enable their practical application.

In the meantime, along with the recent rapid spread of digitization technologies, there is an increased demand for high quality image output such as prints and copies from users in ordinary households, offices and in the publishing domain. To cope with such demands for high quality, an important technical approach is known in which particularly the toners used in electrophotography are improved in resolution by reducing the particle diameter of these toners. At present, the particle diameter of these toners has been reduced to the order of 5 μm. In this regard, when reducing the particle diameter of toners, from the viewpoints of production energy and costs it is difficult to implement the necessary measures to attain a particle diameter of 6 μm or less with grain distribution sufficiently controlled to maintain satisfactory properties for electrophotographic toners using a kneading milling method, which has been used in the production of conventional toners, and, at present, production methods are being shifted to toner production methods using a chemical production method such as a suspension polymerization method, a dissolution suspension method or an emulsion polymerization coagulation method, which are carried out in aqueous media.

Therefore, a more preferable situation would be for it to be possible to apply the low-temperature fixing resin and low-temperature polycondensation technologies explained above, which incorporated low energy and low environmental load technologies, to these aqueous media. However, in the field of the above technologies in which these polycondensation mechanisms are fundamental principles, it has thus far been regarded as difficult to adopt a direct polymerization method in an aqueous medium.

In the case of developing these resins into chemical production method toners, they are usually polycondensed in advance by block polymerization or solution polymerization method to form a high-molecular weight polymer, which is then dispersion-emulsified in an aqueous medium. In this case, it is necessary to control particle diameter and distribution extremely precisely as mentioned above to provide satisfactory performance as required for high quality toners. However, it is very difficult to dispersion-emulsify a resin which has already been given a high-molecular weight by block polymerization or the like, and to do so requires the use of an organic solvent, melting under high-temperature heating, dispersion with high-shearing energy or a classification operation requiring a large amount of energy in a final process. It is hard to attain both a decrease in energy in the electrophotographic process by using the low-temperature fixing resin and in the production technologies for a toner resin. Even if the reduction in energy in the electrophotographic process could be attained by low-temperature fixing or the like, larger energy than in conventional cases is required in the production of the resin. It cannot be said with any certainty that a reduction in energy is achieved when the total energy balance from production of the material product use is taken into account.

Specifically, regarding challenges facing toner production that remain to be addressed in the future, in order to ideally achieve low-environmental load and low energy technologies in, for example, low-temperature fixing in electrophotography, and, at the same time, a toner production method using a chemical production method, which is essential in terms of, for example, meeting the demands for higher quality images required by electrophotography in recent years, technologies that enable easy production of aqueous dispersions of the aforementioned polycondensation resin are thought to be indispensable.

As one noteworthy disclosure for resolving these challenges, there is a report that the polycondensation of a polyester in an aqueous medium, which has previously been thought to be difficult, can be attained (see Saam J C, Chou Y J. U.S. Pat. No. 4,355,154; 1982). In this report, for example, a polyester is polymerization-condensed in an aqueous medium in the presence of a catalyst having a sulfonic acid group.

However, many points regarding the polymerization mechanism in the polymerization condensation method of a polyester in an aqueous medium reported previously remain unclear and this method also has significant drawbacks in terms of production and properties in that the technologies described in this document alone are insufficient to attain the dispersion of particles and stability of an emulsion in the aqueous medium after polymerization, or to obtain a molecular weight sufficient to attain satisfactory image strength required for the toner, when the polyester polycondensation method in an aqueous medium is applied to the production of a polyester for a toner. Also, distribution of particle diameter, charging characteristics and environmental dependency of charging of the resin are unsatisfactory and image quality characteristics and image reliability are very low at present.

As discussed above, it is difficult to obtain a high-molecular weight polymer which can satisfy the characteristics required for electrophotographic toners and, further, the present technologies have not yet reached the level where the polymer is applied to toners because the toners from such a polymer fail to attain compatibility with high quality image characteristics such as grain distribution characteristics and charging characteristics.

### SUMMARY OF THE INVENTION

According to a first aspect of the present invention, there is provided a method of producing a polyester, the method comprising:

emulsifying or dispersing a polyvalent acid component having a hydrophobic parameter (Log(P)) of −0.5 or more and 20 or less, a polyhydric alcohol component having a hydrophobic parameter (Log(P)) of −0.5 or more and 20 or less, and a hydrophobic material having a hydrophobic parameter (Log(P)) of −0.5 or more and 20 or less in an aqueous medium; and

polycondensing the polyvalent acid component with the polyhydric alcohol component in the presence of the hydrophobic material.

According to a second aspect of the invention, there is provided a method of producing an electrostatic developing toner, the method comprising:

emulsifying or dispersing a polyvalent acid component having a hydrophobic parameter (Log(P)) of −0.5 or more and 20 or less, a polyhydric alcohol component having a hydrophobic parameter (Log(P)) of −0.5 or more and 20 or less, and a hydrophobic material having a hydrophobic parameter (Log(P)) of −0.5 or more and 20 or less in an aqueous medium; and

polycondensing the polyvalent acid component with the polyhydric alcohol component in the presence of the hydrophobic material to obtain a polyester resin particle dispersion solution;

coagulating resin particles in a dispersion solution in which at least these resin particles are dispersed to obtain coagulated particles; and

fusing these coagulated particles by heating.

According to a third aspect of the invention, there is provided an electrostatic developing toner comprising at least a colorant and a resin, wherein the resin contains a polyester resin obtained by emulsifying or dispersing a polyvalent acid component having a hydrophobic parameter (Log(P)) of −0.5 or more and 20 or less, a polyhydric alcohol component having a hydrophobic parameter (Log(P)) of −0.5 or more and 20 or less, and a hydrophobic material having a hydrophobic parameter (Log(P)) of −0.5 or more and 20 or less in an aqueous medium, and then polycondensing the polyvalent acid component with the polyhydric alcohol component in the presence of the hydrophobic material.

### DETAILED DESCRIPTION OF THE INVENTION

The inventors of the present invention have made various studies to give a solution to the aforementioned various problems concerning the application of the polycondensation technologies of a polyester in an aqueous medium to a toner and as a result found that these technologies can be industrially applied to an electrophotographic toner. The content of the studies will be explained in detail.

(Method of Producing a Polyester)

The method of producing a polyester in the invention comprises a step of emulsifying or dispersing a polyvalent acid component, a polyhydric alcohol component, and a hydrophobic material in an aqueous medium, and then polycondensing the polyvalent acid component with the polyhydric alcohol component in the presence of the hydrophobic material, wherein as these polyvalent acid component, polyhydric alcohol component and hydrophobic material, those having a hydrophobic parameter (Log(P)) of −0.5 or more and 20 or less are used.

In the method of producing a polyester according to the invention, the polyvalent acid component, the polyhydric alcohol component, and the hydrophobic material each have high hydrophobicity and it is therefore considered that more components can be made to exist in reaction zones (oil phase) in an aqueous medium (water phase). In addition to this, it is considered that if the hydrophobic material having a high hydrophobic parameter is made to exist in an oil phase which is its reaction zone when the polyhydric acid component is polycondensed with the polyhydric alcohol, H₂O generated in the polymerization condensation is discharged (moved) from the reaction zone (oil phase) to the aqueous medium (water phase) efficiently. Also, the discharge of H₂O from the reaction zone is considered to be carried out more efficiently since as the polyvalent acid component and the polyhydric alcohol component, those having a high hydrophobic parameter are used. It is considered from these facts that the polymerization condensation reaction between the polyvalent acid component and the polyhydric alcohol component easily proceeds in the reaction zone (oil phase) and a polyester having a high molecular weight is obtained using a low energy. Also, it is considered that because H₂O is discharged efficiently from the oil phase (reaction zone), polyester particles ensuring the stability of particle dispersion and stability of an emulsion in an aqueous medium are obtained.

Then, the production of a toner by utilizing polyester particles obtained in this manner makes it possible to obtain a toner which is fully satisfied in toner characteristics such as toughness (toner strength, image quality strength), distribution of particle diameter, charging characteristics and environmental dependency of charging. Therefore, the method of producing a polyester according to the invention is most suitable as a method of producing a polyester for electrostatic developing toners.

In the method of producing a polyester according to the invention, those having a hydrophobic parameter (Log(P)) of −0.5 or more are used as the polyvalent acid component, polyhydric alcohol component and hydrophobic material. The hydrophobic parameter (Log(P)) is preferably 1.0 or more and more preferably 1.5 or more. When the hydrophobic parameter (Log(P)) is smaller than −0.5, the molecular weight of the polyester after polymerization condensation in an aqueous medium is unsatisfactory and the resulting polyester has many low-molecular components, allowing the polyester to be inferior in toner characteristics such as toughness (toner strength, image quality strength), distribution of particle diameter, charging characteristics and environmental dependency of charging. Also, in the invention, an increase in these hydrophobic parameters (Log (P)) are more preferable. However, the upper limit of a material which can exist in actual is about 20.

Here, the hydrophobic parameters (Log(P)) carries the implication that the larger the hydrophobic parameters (Log(P)) is, the higher the hydrophobicity is and is generally expressed by the following formula (logarithmic value of a distribution coefficient of a monomer or a material to 1-octanol/water).
Log(P)=Log(Cₒ/C_{w}) Formula:

(In the formula, Cₒ represents the concentration of the monomer or material in 1-octanol at the measuring temperature and C_{w} represents the concentration of the monomer or material in water at the measuring temperature.) The hydrophobic parameter (Log(P)) in the invention is calculated by the method of Ghose-Pritchett-Crippen et al. “Atom Typing Scheme (Journal of Computational Chemistry, Vol. 9, No. 1, 8040, 1988)” which is a calculation chemical atomic group contribution method.

In the method of producing a polyester in the invention, the polyvalent acid component (e.g., aliphatic, alicyclic or aromatic polyvalent carboxylic acids or alkyl esters of these carboxylic acids) and the polyhydric alcohol component (e.g., polyhydric alcohols or their ester compounds) are used to carry out polycondensation directly by an esterification reaction or ester exchange reaction.

The polyester obtained by polycondensation may take any form among amorphous (non-crystalline) polyester, semi-crystalline resin and crystalline resin or mixtures of these forms. In the case of aiming particularly at a low-temperature fixing toner, it is preferable to contain a crystalline polyester having a melting point of 40° C. or more and 150° C. or less.

Examples of the components as the above polyester raw materials used to obtain such a crystalline polyester are as follows. Examples of divalent carboxylic acids among the polyvalent acid components include aliphatic dicarboxylic acids such as adipic acid, suberic acid, azelaic acid, sebacic acid, 1,9-nonanedicarboxylic acid, 1,10-decanedicarboxylic acid, 1,12dodecanedicarboxylic acid, 1,14-tetradecanedicarboxylic acid and 1,18-octadecanedicarboxylic acid and aromatic dicarboxylic acids such as phthalic acid, isophthalic acid, terephthalic acid and naphthalene-2,6dicarboxylic acid. Moreover, anhydrides of these acids and lower alkylesters of these acids are also exemplified although the divalent carboxylic acids which may be used in the invention are not limited to these compounds. Examples of carboxylic acids having three or more valences include 1,2,4benzenetricarboxylic acid, 1,2,5benzenetricarboxylic acid and 1,2,4-naphthalenetricarboxylic acid, and anhydrous materials of these acids. These compounds may be used either singly or in combinations of two or more. Besides the above aliphatic dicarboxylic acids and aromatic dicarboxylic acids, dicarboxylic acid components having a double bond may be contained. The dicarboxylic acid having a double bond may be preferably used to prevent hot offset during fixing because it can crosslink radically. Examples of the dicarboxylic acid include, though not limited to, maleic acid and fumaric acid. Also, lower esters and acid anhydrides of these acids are exemplified.

On the other hand, examples of dihydric alcohols among polyhydric alcohol components include, though not limited to, 1,4butanediol, 1,5-pentanediol, 1,6-hexanediol, 1,4-cyclohexanediol, 1,4-cyclohexanedimethanol, 1,7-heptanediol, 1,8-octanediol, 1,9-nonanediol, 1,10-decanediol, 1,11-undecanediol, 1,12-dodecanediol, 1,13tridecanediol, 1,14-tetradecanediol, 1,18-octadecanediol, 1,14-eicosadecanediol, ethylene oxide adducts of bisphenol A, and propylene oxide adducts of bisphenol A. Also, examples of alcohols having three or more valences include trimethylolpropane.

These compounds may be used either singly or in combinations of two or more. Although examples of monomer components are given as each of these components, an oligomer (including a dimer) is preferably used as a part or all of the component to prepare a high-molecular polyester. Specifically, before each monomer is emulsified or dispersed in an aqueous medium, it is subjected to prepolymerization condensation to polycondense a part or all of the monomers to form oligomers (including a dimer) (polyester is block-polymerized or solution-polymerized to form a precursor having a low-molecular weight) and then, this precursor is emulsified and dispersed as starting material in an aqueous medium to polycondense to a polyester. The molecular weight of each of these oligomers is preferably 3,000 or less in terms of weight average molecular weight. The existence of the oligomer results in an improvement in the hydrophobicity of the component (the hydrophobicity of the oil phase increases), which promotes the polycondensation of the polyester more efficiently to thereby increase the molecular weight of the polyester.

There is also the case where the Log(P) becomes −0.5 or less when these monomers are used singly. When the Log(P) of the monomer is −0.5 or less, the monomer is copolymerized with a monomer having a larger Log(P) in advance to prepare a low-molecular derivative, whereby the use of the monomer is made possible. For example, as mentioned above, an oligomer (including a dimer) which is polymerized in advance by bulk polymerization or solution polymerization is used as the starting material of the aqueous polycondensation. Namely, even if a component having a log (P) of −0.5 or less is used as the monomer, the Log(P) can be adjusted to −0.5 or more by copolymerizing the component with other monomer in advance, whereby the freedom of a copolymer composition can be increased. In this case, as the Log(P), the Log(P) based on the weight average of Log(P) of each monomer used for oligomer polymerization is used. Then, the weight average of this Log(P) and the log (P) of the monomer used afterward for chain extension is found. In the invention, it is only required that the resulting Log(P) value satisfies the requirement of the invention.

Also, the absolute value (|Log(P)_{COOH}−Log(P)_{OH}|) of the difference between the hydrophobic parameter (Log(P)_{COOH}) of the polyvalent acid component and the hydrophobic parameter (Log(P)_{OH}) of the polyhydric alcohol component is preferably 5.0 or less, more preferably 4.7 or less and still more preferably 3.0 or less. If this absolute value (maximum value) of the difference between the hydrophobic parameters is made to fall in the above range, the degrees of hydrophobicity (the degrees of solubility in water) of the polyvalent acid component and polyhydric alcohol component become almost the same to thereby allow the coefficients of distribution to water phase/oil phase to be almost the same, which makes it easy to adjust the chemical equivalents of the both and to promote the polycondensation of the polyester more efficiently, whereby a high-molecular weight polyester can be attained. It is to be noted that because the absolute value (|Log(P)_{COOH}−Log(P)_{OH}|) of the difference between the hydrophobic parameter (Log(P)_{COOH}) of the polyvalent acid component and the hydrophobic parameter (Log(P)_{OH}) of the polyhydric alcohol component is preferably smaller, this includes the case where there is no difference between the both and therefore the lower limit of this value is 0.

In the method of producing a polyester according to the invention, the above polymerization condensation is carried out in the presence of a hydrophobic material having a hydrophobic parameter of −0.5 or more and 20 or less. Examples of the hydrophobic material include polymerizable monomers and organic solvents (e.g., toluene, xylene, methyl ethyl ketone and methyl isobutyl ketone). Among these materials, organic solvents are not desirable because a solvent-removing operation must be carried out, and there is therefore a fear that the production cost is increased. In the case of a polymerizable monomer, especially, radically polymerizable monomer, on the other hand, it is polymerized with a polyester to form a hybrid resin, whereby it becomes needless to remove solvents and the polymerizable monomer is therefore preferable. Among these monomers, radically polymerizable monomers are most preferable.

In the invention, when the hydrophobic material is added in an aqueous medium together with the polyester raw material to run a polyester polycondensation reaction in the presence of the hydrophobic material, the polyester raw material is embraced in the radial polymerizable monomer and the polycondensation reaction progresses more efficiently, whereby a high-molecular weight polyester can be attained.

Examples of the radically polymerizable monomer may include aromatic vinyl monomers, (meth)acrylate monomers, vinyl ester monomers, vinyl ether monomers, monoolefin monomers, diolefin monomers, and halogenated olefin monomers. Examples of the aromatic vinyl monomer include styrene monomers such as styrene, o-methylstyrene, m-nethylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, and 3,4-dichlorostyrene, and their derivatives. Examples of the (meth)acrylate monomer include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl-β-hydroxy acrylate, propyl γ-aminoacrylate, stearyl methacrylate, dimethylaminoethyl methacrylate, and diethylaminoethyl methacrylate. Examples of the vinyl ester monomer include vinyl acetate, vinyl propionate, and vinyl benzoate. Examples of the vinyl ether monomer include vinyl methyl ether, vinyl ethyl ether, vinyl isobutyl ether and vinyl phenyl ether. Examples of the monoolefin monomer include ethylene, propylene, isobutylene, 1-butene, 1-pentene, and 4-methyl-1-pentene. Examples of the diolefin monomer include butadiene, isoprene, and chloroprene. Examples of the halogenated olefin monomer include vinyl chloride, vinylidene chloride and vinyl bromide. These monomers may be used either singly or in combinations of two or more.

Also, if these radically polymerizable monomers are polymerized, hybrid resins (their particles) combined with the polyester can be obtained. This polymerization may be run at the same time or in succession to the polycondensation of the polyester. Also, these radically polymerizable monomers may be further polymerized by adding new monomers after the polyester polymerization.

These radically polymerizable monomers sometimes have a Log(P) of −0.5 or less when used singly. In the case where the Log(P) is −0.5 or less, the monomer is copolymerized with a monomer having a larger Log(P) to prepare a derivative of a polymerizable low-molecular body. This enables the use of these polymerizable monomers.

In the method of producing the polyester in the invention, it is particularly effective to use a Brønsted polycondensation catalyst or an enzyme catalyst to attain polycondensation at lower temperatures. The polycondensation may be run at a temperature lower than 150° C. or less (preferably 100° C. or less) by adding one or more of these catalysts in advance in a proportion of about 0.1 to 10,000 ppm together with the polyester raw material in an aqueous medium.

Examples of the Brønsted catalyst include inorganic acids, organic acids, and rare earth element catalysts. In view of attaining polycandensation at low temperature, particularly, as the Brønsted type catalyst, a rare earth element catalyst using a rare earth element selected from Y, Sc, Yb and Sm as its constituent component is preferably used.

Examples of the inorganic acid include sulfuric acid, hydrochloric acid and hydrobromic acid. Among these acids, inorganic acids having a sulfonic acid group are preferable.

Examples of the organic acid include organic acids having a sulfonic acid group such as dodecylbenzenesulfonic acid and polystyrenesulfonic acid and styrene copolymers of these acids.

The rare earth element catalyst preferably contains at least one element selected from, particularly, Y, Sc, Yb and Sm and preferable examples of the form of the catalyst may include triflate form or trisdodecyl sulfuric acid form. Specific examples of the form include scandium trisdodecylsulfate.

In the meantime, examples of the enzyme catalyst include lipase, protease, cellulase, and lipase. Specific examples of these enzymatic materials include those derived from Pseudomonas fluorescence, those derived from Pseudomonas cepasia, those derived from Porcine pancreas, those derived from Candida rugosa, those derived from Aspergillus niger, those derived from Rhizopus delemer, and those derived from Rhizopus japonicus).

These catalysts are usually used independently. However, plural catalysts may be used according to the need. Also, among the aforementioned catalyst compounds and surfactant type catalysts, those which are more hydrophobic and have a large molecular weight are preferably selected from the viewpoint of the amount of the catalyst to be used, as it is considered that the catalyst is distributed together with the polyester emulsion or particles in an aqueous medium. The surfactant type catalysts are particularly preferable. Preferable examples of the surfactant type catalyst include scandium trisdodecylsulfate.

Here, the surfactant type catalysts, namely, catalysts having surfactant activity mean catalysts having a chemical structure including a hydrophobic group and a hydrophilic group. Although catalysts usually tend to move to water, the surfactant type catalyst adsorbs to the surface of the resin particles and is easily participated in the polymerization reaction in the oil phase, and therefore the polymerization reaction can be promoted more efficiently.

As the method of polymerizing the above radically polymerizable monomer, known polymerization methods such as a method using a radically polymerizable initiator, a self-polymerization method using heat, and a method using radiation of ultraviolet rays may be adopted. In this case, as to the method using a radical initiator, the radical polymerization initiators include an oil-soluble type and water-soluble type, and both of these types may be used.

Examples of the radical initiator include ammonium persulfate, potassium persulfate, sodium persulfate, 2,2-azobis[2-nethylpropionamido]dihydrochloride, t-butyl peroxy-2-ethylhexanoate, cumyl perpivalate, t-butyl peroxylaurate, benzoyl peroxide, lauroyl peroxide, octanoyl peroxide, di-t-butyl peroxide, t-butylcumyl peroxide, dicumyl peroxide, 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1,1-bis(t-butylperoxy)3,3,5-trimethylcyclohexane, 1,1-bis(t-butylperoxy)cyclohexane, 1,4-bis(t-butylperoxycarbonyl)cyclohexane, 2,2bis(t-butylperoxy)octane, n-butyl-4,4-bis(t-butylperoxy)valerate, 2,2bis(t-butylperoxy)butane, 1,3bis(t-butylperoxyisopropyl)benzene, 2,5-dimethyl-2,5-di(t-butylperoxy)hexane, 2,5-dimethyl-2,5-di(t-butylperoxy)hexane, 2,5-dimethyl-2,5-di(benzoylperoxy)hexane, di-t-butyl diperoxyisophthalate, 2,2bis(4,4-di-t-butylperoxycyclohexyl)propane, di-t-butyl peroxy-α-methylsuccinate, di-t-butyl peroxydimethyl glutarate, di-t-butyl peroxyhexahydroterephthalate, di-t-butyl peroxyazelate, 2,5-dimethyl-2,5-di(t-butylperoxy)hexane, diethylene glycol-bis(t-butylperoxycarbonate), di-t-butyl peroxytrimethyl adipate, tris(t-butylperoxy)triazine, vinyltris(t-butylperoxy)silane, 2,2′-azobis(2-methylpropioneamidine dihydrochloride, 2,2′-azobis[N-2-carboxyethyl)-2-methylpropioneamidine], and 4,4′-azobis(4-cyanovaleric acid).

In the method of producing a polyester in the invention, it is preferable to adjust the acid value of the obtained polyester to 0.5 mgKOH/g or more and 40 mgKOH/g or less. In order to put the polyester to practical use as the raw material of a high quality toner, it is necessary and indispensable to control the particle diameter and distribution in an aqueous medium. In the case where the acid value is less than 0.5 mgKOH/g, only unsatisfactory particle diameter and distribution may be attained and there is therefore the case where this may pose problems concerning image quality and productivity. Moreover, with regard to the charging characteristics of the toner, there is the case where only insufficient charging characteristics may be obtained when the acid value is less than 0.5 mgKOH/g. When the acid value exceeds 40 mgKOH/g, on the other hand, there is the case where it may be difficult to obtain a desired molecular weight large enough to obtain the image quality strength required for the toner in the polycondensation and also the environmental dependency of the charging characteristics of the toner under highly humidified conditions may be large, which greatly may impair the reliability of an image.

Here, as the acid value in the invention, values measured by a potentiometric titration method according to JIS K0070 are used.

In the method of producing a polyester in the invention, each of the aforementioned materials is emulsified or dispersed in an aqueous medium by means of, for example, mechanical shear or ultrasonic wave. In this case, the monomer may be directly emulsified or dispersed or may be emulsified or dispersed after the monomer is subjected to block polymerization or solution polymerization in advance to form a precursor having a low-molecular weight. In this emulsification or dispersion, the radically polymerizable monomer may be compounded to make easily the emulsion dispersion and polycondensation reaction as mentioned above. In this emulsification and dispersion, it is possible to add, for example, a surfactant, a high-molecular dispersant and an inorganic dispersant in an aqueous medium according to the need.

Examples of the surfactant used here include anionic surfactants such as sulfate types, sulfonate types and phosphate types; cationic surfactants such as amine salt types and quaternary ammonium salt types; nonionic surfactants such as polyethylene glycol types, alkylphenolethylene oxide addition types and polyhydric alcohol types. Among these surfactants, anionic surfactants and cationic surfactants are preferable. The aforementioned nonionic surfactants are preferably used in combination with the aforementioned anionic surfactants or cationic surfactants. These surfactants may be used either singly or in combinations of two or more. Examples of the anionic surfactant include sodium dodecylbenzenesulfonate, sodium alkylnaphthalenesulfonate, sodium arylalkyl polyether sulfonate, sodium 3,3-disulfonediphenylurea-4,4-diazo-bis-amino-8-naphthol-6-sulfonate, ortho-carboxybenzene-azo-dimethylaniline, sodium 2,2,5,5-tetramethyl-triphenylmethane-4,4-diazo-bis-β-naphthol-6-sulfonate, sodium dialkylsulfosuccinate, sodium dodecylsulfate, sodium tetradecylsulfate, sodium pentadecylsulfate, sodium octylsulfate, sodium oleate, sodium laurate, sodium caprate, sodium caprylate, sodium caproate, potassium stearate, and calcium oleate. Examples of the cationic surfactant include alkylbenzenedimethylammonium chloride, alkyltrimethylammonium chloride, and distearylammonium chloride. Examples of the nonionic surfactant may include polyethylene oxide, polypropylene oxide, combinations of polypropylene oxide and polyethylene oxide, esters of polyethylene glycol and higher fatty acid, alkylphenolpolyethylene oxide, esters of higher fatty acid and polyethylene glycol, esters of higher fatty acid and polypropylene oxide and sorbitan esters. Also, examples of the high-molecular dispersant may include sodium polycarboxylate and polyvinyl alcohol. Examples of the inorganic dispersant may include calcium carbonate. These examples are not intended to be limiting of the invention. Higher alcohols typified by heptanol and octanol and higher aliphatic hydrocarbons typified by hexadecane may be frequently compounded as stabilizer adjuvants to prevent the Ostwald ripening phenomenon of monomer emulsion particles in an aqueous medium in usual.

In the method of producing a polyester according to the invention, components generally necessary for toners such as colorants, fixing adjuvants such as waxes and other charging adjuvants may be mixed in advance together with the raw materials of the polyester in the monomer. Also, when the radically polymerizable monomer is radically polymerized to obtain a hybrid resin (its particles), the radically polymerizable monomer can be further added in a minute amount in the aqueous medium after the polyester is polycondensed. The surface of the polymerized particles can be reformed and the acid value can be controlled by this treatment. As such a radically polymerizable monomer, the vinyl monomer mentioned above may be used in the same manner. For example, acidic vinyl monomers such as acrylic acid, methacrylic acid, fumaric acid, maleic acid and itaconic acid are particularly useful to reform the surface of the particles and the acid value of a final polymer.

In the method of producing a polyester according to the invention, the polyester obtained in the aqueous medium has a particle form. Its final average particle diameter is preferably 10 μm or less, more preferably him or less and most preferably 0.7 μm or less in terms of its volume center particle diameter. When this particle diameter exceeds 10 μm, this may be undesirable in view of resolution and image quality characteristics when the polyester is used as a toner. Further, when the particle diameter exceeds 10 μm, an increase in molecular weight and the rate of the increase in the polymerization and condensation may be insufficient, posing problems concerning image quality strength after the image is fixed.

As mentioned above, it is recommended to adopt a heterogeneous polymerization form in a usual aqueous medium which form is obtained by, for example, a suspension polymerization method, solution suspension method, mini-emulsion method, or micro-emulsion method as a polymerization method. Also, in this case, polymerization methods, such as a mini-emulsion method and micro-emulsion method, providing submicron particles having a diameter of 1 μm or less as its final form are more preferable as a production process making it possible to attain a particle diameter of 0.7 μm or less which is the most preferable form of particle diameter because the polycondensation reaction and particularly, the final molecular weight and the polymerization rate depend on the final particle diameter of the particle as mentioned above.

In the case of intending to obtain toner particles having a particle diameter of 1 μm or more which are being practically used as a toner, it is possible to adjust the particle diameter and distribution of the toner by a method of coagulating and fusing particles containing colorant particles (when colorants are added in advance in final polyester particles, these polyester particles themselves are the colorant particles) such as a known emulsion polymerization method.

In the method of producing a polyester according to the invention, as explained above, the hydrophobic material (particularly, a vinyl monomer) is added together with the polyester raw materials (polycondensation monomer) in advance in an aqueous medium to run a polycondensation reaction under the presence of the hydrophobic material (particularly, a vinyl monomer) in the aqueous medium, with the result that polycondensation are promoted so that a high-molecular polyester is attained. Also, a hybrid resin (its particles) can be obtained by polymerizing a vinyl monomer as the hydrophobic material.

In addition, in order to control the polycondensation in an aqueous medium easily at a higher polymerization rate so as to obtain a higher molecular weight, a low-molecular weight polymer (oligomer) is formed from the raw materials of the polyester by block polymerization and solution polymerization and is then emulsified or dispersed in an aqueous medium, followed by further running a polycondensation reaction to make the polyester have a final molecular weight. Also, in this case, the hydrophobic material (particularly, a vinyl monomer) may be blended with the low-molecular polyester (oligomer) and then emulsified or dispersed. Also, the method in which the acid value of the final polymer is controlled as mentioned above or these measures are preferably combined. Also, it is possible to use measures in which the prepolymerization method using the radically polymerizable monomer and the polyester is combined.

(Method of Producing an Electrostatic Developing Toner)

A most preferable method of producing an electrostatic developing toner according to the invention comprises at least a step (coagulation step) of coagulating resin particles in a dispersion solution in which the resin particles are dispersed, to obtain coagulated particles and a step (fusing step) of heating the coagulated particles to fuse these particles. In the production method called an emulsification polymerization coagulating method, the resin particles are obtained by the method of producing a polyester according to the present invention.

In the coagulation step, the polyester particles (resin particles) obtained in the above method of producing a polyester according to the invention are prepared in an aqueous medium and therefore utilized as a resin dispersion solution as it is. Also, this resin particle dispersion solution may be blended with a colorant particle dispersion solution and a releasing agent particle dispersion solution and a coagulant is further added to the resulting mixed solution to thereby cause hetero-coagulation of these particles, whereby coagulated particles having a toner diameter can be formed. Also, after these particles are coagulated in this manner to form first coagulated particles, further the polyester particles or a separate polymer dispersion solution may be added to form a second shell layer on the surface of the first particles. It is to be noted that although, in this example, the colorant dispersion solution is separately prepared, the colorant dispersion solution is unnecessary when colorants are compounded in advance in the polyester particles.

After that, in the fusing step, the resulting solution is heated to a temperature above the glass transition temperature or melting point of the polyester particles to fuse or unite the coagulated particles, followed by washing and drying according to the need, whereby a toner can be obtained.

As to the shape of the toner, an amorphous form to a spherical form are preferably used. Also, as the coagulant, inorganic salts and metal salts having two or more valences are preferably used besides the surfactant. The use of the metal salt is preferable in view of characteristics such as coagulating ability control and toner charging characteristics.

The following explanations will be furnished as to the constitutional component of the toner to be used.

First, examples of the colorant include various pigments, for example, carbon black such as furnace black, channel black, acetylene black and thermal black, inorganic pigments such as iron oxide red, iron blue and titanium oxide, azo pigments such as Fast Yellow, disazo Yellow, pyrazolone Red, chelate Red, Brilliant Carmine and para Brown, phthalocyanine pigments such as copper phthalocyanine and metal-free phthalocyanine and condensed polycyclic pigments such as flavanthrone Yellow, dibromoanthrone Orange, perylene Red, quinacridone Red and dioxazine Violet. Other examples of the colorant include Chrome Yellow, Hansa Yellow, Benzidine Yellow, Indanthrene Yellow, Quinoline Yellow, Permanent Orange GTR, Pyrazolone Orange, Vulcan Orange, Watchung Red, Permanent Red, DuPont Oil Red, Lithol Red, Rhodamine B Lake, Lake Red C, Rose Bengale, Aniline Blue, Ultramarine Blue, Chalcoil Blue, Methylene Blue Chloride, Phthalocyanine Blue, Phthalocyanine Green, Malachite Green Oxalate, C.I. Pigment Red 48:1, C.I. Pigment Red 122, C.I. Pigment Red 57:1, C.I. Pigment Yellow 12, C.I. Pigment Yellow 97, C.I. Pigment Yellow 17, C.I. Pigment Blue 15:1 and C.I. Pigment Blue 15:3. These pigments may be used either singly or in combinations of two or more.

Examples of the releasing agent include, though not limited to, natural waxes such as carnauba wax, rice wax and candelilla wax, synthetic or mineral/petroleum waxes such as low-molecular polypropylene, low-molecular polyethylene, sazole wax, microcrystalline wax, Fisher-Tropsch wax, paraffin wax and montan wax, ester type waxes such as fatty acid esters and montanic acid ester. Also, these releasing agents may be used either singly or in combinations of two or more. The melting point of the releasing agent is preferably 50° C. or more and more preferably 60° C. or more from the viewpoint of preserving characteristics, and preferably 110° C. or less and more preferably 100° C. or less from the viewpoint of anti-offset characteristics.

In addition to the above, various components such as internal additives, charge control agents, inorganic powders (inorganic microparticles) and organic microparticles may be added. Examples of the internal additives include magnetic materials, for example, metals and alloys such as ferrite, magnetite, reduced iron, cobalt, nickel and manganese and compounds containing these metals. Examples of the charge control agent include quaternary ammonium salt compounds, nigrosine type compounds, dyes comprising complexes of aluminum, iron or chromium and triphenylmethane type pigments. Also, the inorganic powder is added primarily for the purpose of regulating the viscoelasticity of the toner and examples of the inorganic powder include all inorganic microparticles, such as silica, alumina, titania, calcium carbonate, magnesium carbonate, calcium phosphate and cerium oxide which are used as external additives to be added to the surface of the toner.

The toner obtained by the method of producing an electrostatic developing toner according to the invention which is explained above is used as an electrostatic developer. No particular limitation is imposed on this developer insofar as it contains this electrostatic image developing toner and the developer may have a desired component composition according to the object. When the electrostatic developing toner is used singly, it is prepared as a one-component type electrostatic image developer whereas when it is used in combination with a carrier, it is prepared a two-component type electrostatic image developer.

No particular limitation is imposed on the carrier and examples of the carrier include known carriers and, for example, known carriers such as resin coated carriers as described in each publication of Japanese Patent Application Laid-)pen (JP-A) Nos. 62-39879 and 56-11461 may be used.

Given as specific examples of the carrier are the following resin-coated carriers. Namely, examples of the core particle include usual iron powders, ferrite and magnetite articles and the average particle diameter of the particles is about 30 to 200 μm. The resin with which the above core particles are coated include styrenes such as styrene, parachlorostyrene and α-methylstyrene, α-methylene fatty acid monocarboxylic acids such as methyl acrylate, ethyl acrylate, n-propyl acrylate, lauryl acrylate, 2-ethylhexyl acrylate, methyl methacrylate, n-propyl methacrylate, lauryl methacrylate and 2-ethylhexyl methacrylate, nitrogen-containing acryls such as dimethylaminoethyl methacrylate, vinylnitriles such as acrylonitrile and methacrylonitrile, vinylpyridines such as 2-vinylpyridine and 4-vinylpyridine, vinyl ethers such as vinyl methyl ether and vinyl isobutyl ether, vinyl ketones such as vinyl methyl ketone, vinyl ethyl ketone and vinyl isopropenyl ketone, polyolefins such as ethylene and propylene, silicones such as methyl silicone and methylphenyl silicone, copolymers of vinyl type fluorine-containing monomers such as vinylidene fluoride, tetrafluoroethylene and hexafluoroethylene, polyesters containing bisphenol, glycol or the like, epoxy resins, polyurethane resins, polyamide resins, cellulose resins and polyether resins. These resins may be used either singly or in combinations of two or more. The amount of the coating resin is about 0.1 to 10 parts and preferably 0.5 to 3.0 parts based on the carrier. In the production of the above carrier, a heating type kneader, heating type Henschel Mixer, UM Mixer or the like may be used. A heating type fluid rolling bed, heating type kiln or the like may be used though this depends on the amount of the above coating resin.

There is no particular limitation to the mixing ratio of the electrostatic developing toner and the carrier in the electrostatic developer and the mixing ratio may be optionally selected according to the object.

Also, the electrostatic developer (electrostatic developing toner) may be used in a usual electrostatic developing system (electrophotographic system) image forming method. The image forming method of the invention specifically involves an electrostatic latent image forming step, a toner image forming step, a transfer step and a cleaning step. Each of the aforementioned steps is itself a usual step and is described in, for example, in each publication of JP-A Nos. 56-40868 and 49-91231. The image forming method using the electrostatic developing toner of the invention may be practiced using a known image forming device such as a copy machine or a facsimile. The aforementioned electrostatic latent image forming step is a step of forming an electrostatic latent image on an electrostatic latent image support. The aforementioned toner image forming step is a step of developing the above electrostatic latent image by the developer layer on the developer support to form a toner image. No particular limitation is imposed on the above developer layer insofar as it includes the electrostatic image developer containing the electrostatic image developing toner of the invention. The aforementioned transfer step is a step of transferring the above toner image to a transfer body. The aforementioned cleaning step is a step of removing the electrostatic image developer left on the electrostatic latent image support. In the image forming method using the electrostatic image toner of the invention, an embodiment further comprising a recycle step is preferable. The recycle step is a step of transferring the electrostatic image developing toner recovered in the cleaning step to the developer layer. The image forming method of this embodiment involving the recycle step can be practiced using an image forming device such as a toner recycle system type copy machine and facsimile machine. Also, the image forming method may be applied to a recycle system of an embodiment in which a toner is recovered at the same time when an image is developed.

### EXAMPLES

The present invention will be explained in more detail by way of examples. However, the following Examples should not be construed to limit the scope of the invention. In the following explanations, all designations of “parts” indicate “parts by mass”, unless otherwise noted.

(Methods of Measuring a Grain Size and Grain Distribution)

Measurement of the grain size and grain distribution in the invention will be explained. When the particle to be measured in the invention has a size of 2 μm or more, a Coulter Counter TA-II model (manufactured by Beckmann Coulter Company) is used as a measuring device and an ISOTON-II (manufactured by Beckmann Coulter Company) is used as an electrolyte.

As to a measuring method, 0.5 to 50 mg of a measuring sample is added in 2 ml of an aqueous 5% solution of a surfactant, and preferably sodium alkylbenzenesulfonate, as a dispersant. The solution is added in 100 to 150 ml of the electrolyte.

The electrolyte in which the sample is suspended is subjected to a ultrasonic dispersing machine to carry out dispersion treatment for about one minute, thereby measuring the grain distribution of particles 2 to 60 μm in size by using the aforementioned Coulter Counter TA-II model with an aperture having an aperture diameter of 100 μm, thereby finding volume average distribution and number average distribution. The number of particles to be measured is 50,000.

Also, the grain distribution of the toner in the invention is found by the following method. Based on the measured grain distribution, a volume average distribution in each divided size range (channel) is cumulated from the smaller particle side to describe a curve. The volume average particle diameters at which the cumulations become 16% and 50% are defined as D16 and D50 respectively. Moreover, the volume average particle diameters at which the cumulation becomes 84% is defined as D84.

The volume average particle diameter in the invention is the D50 and GSD is calculated by the following equation.
GSD=(D84/D 16)^{0.5} Equation:

Similarly, based on the measured grain distribution, a number average distribution in each divided size range (channel) is cumulated from the smaller particle side to describe a curve. The particle diameters at which the cumulation becomes 50% is defined as number average particle diameter.

Also, when particles to be measured in the invention is less than 2 μm in size, these particles are measured using a laser diffraction grain distribution measuring device (trade name: LA-700, manufactured by Horiba, Ltd.). As a measuring method, a sample put in a dispersion solution state is prepared such that the solid content is about 2 g. Ion exchange water is added to the dispersion solution to be a volume of about 40 ml. The resulting solution is charged in a cell until the concentration becomes a proper one. When the concentration in the cell is almost stable after two minutes, the sample is measured. The obtained volume average particle diameter every channel is cumulated from the smaller volume average diameter side to define the volume average particle diameter at which the cumulation is 50% as volume average particle diameter.

(Method of Measuring the Weight Average Molecular Weight of the Toner)

The weight average molecular weight of the electrostatic image developing toner is measured in the following conditions. GPC is carried out using a device (trade name: HLC-8120 GPC, SC-8020, manufactured by Tosoh Corporation), two columns (TSK gel, Super HM-H, manufactured by Tosoh Corporation, 6.0 mm ID×15 cm) and THF (tetrahydrofuran) as an eluent. The test is made in the following condition: concentration of the sample: 0.5%, flow rate: 0.6 ml/min, amount of the sample to be injected: 10 μl and measuring temperature: 40° C., using an IR detector. The calibration curve is prepared from 10 samples, namely, “polystyrene standard sample TSK standard, manufactured by Tosoh Corporation”: “A-500”, “F-1”, “F-10”, “F-80”, “F-380”, “A-2500”, “F4”, “F40”, “F-128” and “F-700”.

(Methods of Measuring the Melting Point and Glass Transition Temperature of the Toner)

The melting point and glass transition temperature of the toner are found from a principal maximum peak measured according to ASTMD 3418-8.

DSC-7 manufactured by PerkinElmer Japan Co., Ltd. may be used for the measurement of the principal maximum peak. The melting points of indium and zinc are used for the temperature calibration of the detective part of this device and the heat of fusion of indium is used for the calibration of calories. An aluminum pan is used for the sample and an empty pan for control is set to carry out measurement at a temperature rise rate of 10° C./min.

(Measurement of Crystallinity)

Whether the resin of the present invention has crystallinity or not is determined in the following manner using the definition of fusion temperature in JIS K7121. The case where in the curve of heat absorption measured by the above method, a difference in temperature between the point of intersection (starting temperature of fusion) at which a line obtained by extending the low-temperature side base line toward the high-temperature side intersects with a tangential line drawn on the low-temperature side curve of the peak of fusion (heat absorption peak) at the point where the gradient reaches a maximum and the point of intersection (finish temperature of fusion) at which a line obtained by extending the high-temperature side base line toward the low-temperature side intersects with a tangential line drawn on the high-temperature side curve of the peak of fusion (heat absorption peak) at the point where the gradient reaches a maximum is within 50° C. and the curve does not show a step form shown in JIS K7121 is judged that the resin has crystallinity.

### Example 1

—Polymerization of a Polyester Resin (1) —

A three-neck flask is charged with 80 parts of 1,9-nonanediol (Log(P)=1.86), 115.2 parts of 1,10-dodecanoic diacid (Log(P)=2.7), 156.1 parts of a styrene monomer (Log(P)=2.67), 39.1 parts of butylacrylate monomer (Log(P)=1.88), 2 parts of hexadecane (Log(P)=7.18) and 2 parts of dodecanethiol (Log(P)=5.14), which are then thoroughly mixed at 80° C. and cooled to ambient temperature. Then, 2.0 parts of scandium trifluoromethanesulfonate [Sc(OSO₂CF₃)₃] is added as a catalyst to the mixture and dissolved.

This mixture is poured into 1377 parts of ion exchange water in which 11 parts of sodium dodecylbenzenesulfonate and 4 parts of scandium trisdodecylsulfate are dissolved. The solution is predispersed by ultrasonic wave and further emulsion-dispersed at 80° C. by using an extra-high pressure homogenizer (trade name: Nanomizer, manufactured by Yoshida Kikai Kogyo Co.), to obtain an emulsion having a volume average particle diameter of 0.2 μm.

This emulsion is poured into a 3 L pressure type reactor equipped with a stirrer to run polymerization at 100° C. for 12 hours under a nitrogen atmosphere to obtain a resin microparticle dispersion solution (1). The reaction product retains a stable emulsion state and has a volume average particle diameter of 0.2 μm. The ratio SD (volume average particle diameter/number average particle diameter) of the volume average particle diameter to the number average particle diameter is 1.3.

The sample after the reaction is finished is taken out in a small amount and dried at ambient temperature. The solid left non-vaporized is washed with methanol, filtered and dried in an oven to take out the polymerized polymer. The weight average molecular weight of the polymer is 25,000. Also, the composition ratio of radically polymerizable polymers such as a polystyrene/butylacrylate copolymer and a polyester in the polymer is investigated by proton NMR (manufactured by Varian Co., 300 MHz) using chloroform deuteride and as a result, the yield of styrene or butylacrylate and its copolymer is 2% or less. At this time, it is considered that all of the polymer components are almost polyesters. Further, the acid value of this polymer composition (polyester resin) obtained after it is dissolved in THF by using an ethanol solution of potassium hydroxide is measured to find that the acid value is 10 mgKOH/g.

Further, the thermal characteristics and crystallinity of this resin are measured and as a result, the resin is found to be a crystalline resin having a melting point of 71° C.

—Polymerization of a Radically Polymerizable Monomer (1)—

3.9 parts of acrylic acid is added to the resin dispersion solution (1) obtained above and the mixture is allowed to stand at 80° C. with stirring to distribute the acrylic acid sufficiently into the resin microparticles. A solution obtained by dissolving 2.0 parts of ammonium persulfate in 10 parts of ion exchange water is added to the above resin solution and the mixture is polymerized again at 80° C. for further 5 hours under a nitrogen atmosphere to obtain a stable resin microparticle dispersion solution (2) having a volume average particle diameter of 0.2 μm and a SD of 1.3.

After polymerized, a small amount of the sample is taken out and dried to remove water at ambient temperature. Then, in the same manner as in the above polymerization of the polyester, the sample is washed with methanol, subjected to filtration and dried. Then, the ratio of a polyester to a radically polymerizable polymer in the polymer is found by proton NMR to thereby find the yield of the radically polymerizable polymer, with the result that the compounded radical monomer is participated in a polymerization reaction and the yield of the radically polymerizable polymer is 99% or more. Also, the total amount of the radical monomer component left unreacted is found to be 200 ppm or less from gas-chromatographic analysis of the emulsion. Moreover, when the molecular weight of the radical monomer component is measured by GPC, the weight average molecular weight is 31,000, which is almost the same as that of the polyester polymerized previously. The radically polymerizable polymer exhibits a molecular weight falling in almost the same range of at least the above polyester resin. Also, the melting point of the polyester is kept at 71° C.

—Production of a Toner Particle (1)—

—Preparation of a Pigment Dispersion Solution—

100 parts of a cyan pigment (trade name: Pigment Blue 15:3, manufactured by Dainichiseika Color & Chemicals Mfg. Co., Ltd.), 15 parts of an anionic surfactant (trade name: Neogen R, manufactured by Dai-ichi Kogyo Seiyaku Co., Ltd.) and 900 parts of ion exchange water are mixed, dissolved and dispersed for about one hour by using a high-pressure impact type dispersing machine Ultimizer (trade name: HJP 30006, manufactured by (K.K.) Sugino Machine) to prepare a cyan pigment dispersion solution. The average particle diameter of the dispersed cyan pigment is 0.15 μm and the concentration of the colorant particles is 23% by weight.

—Preparation of an Ester Wax Dispersion Solution—

50 parts of an ester wax (trade name: WE-2, melting point: 65° C., manufactured by Nippon Oil & Fats Co., Ltd.), 5 parts of an anionic surfactant (trade name: Neogen RK, manufactured by Dai-ichi Kogyo Seiyaku Co., Ltd.) and 200 parts of ion exchange water are heated to 95° C. and dispersed using a homogenizer (trade name: Ultraturrax T50, manufactured by IKA Co.). Then, the mixture is subjected to a Manton Gohlin High-pressure Homogenizer (Gohlin Company) for dispersing treatment to prepare an ester wax dispersion solution having an average particle diameter of 0.23 μm and a particle concentration of 20% by weight.

—Preparation of the Toner Particle (1): Emulsion Polymerization Coagulation Method—

A 2 L cylindrical stainless container is charged with 400 parts of the resin microparticle dispersion solution (2) obtained by polymerizing the aforementioned radically polymerizable monomer, 34.4 parts of the above pigment dispersion solution, 33 parts of an ester wax dispersion solution and 265 parts of ion exchange water and these components are dispersed and mixed by Ultraturrax at 8,000 rpm with applying shearing force. Then, 0.18 parts of an aqueous 10% nitric acid solution of aluminum polychloride is added dropwise as a coagulant. At this time, the raw material dispersion solution is adjusted to pH range from 2.8 to 3.2 by adding an aqueous 0.1 N sodium hydroxide solution and an aqueous 0.1 N nitric acid solution.

Thereafter, the resin particles, pigment particles and wax particles are gradually heated and coagulated with stirring the raw material dispersion solution, to adjust the volume average particle diameter (trade name: TA-II model, manufactured by Coulter Counter, Aperture diameter: 50 μm) to 6.0 μm in a stainless steel polymerization kettle equipped with a stirrer and a temperature gage. Thereafter, the dispersion solution is adjusted up to pH 9.0 and raised to 95° C. and kept in this condition for 3 hours to obtain potato-shaped toner particles having an average particle diameter of 6.0 μm and a volume average particle diameter distribution (GSDv) of 1.23. Then, these toner particles are cooled, screened by a 45 mesh screen and sufficiently washed with water repeatedly, followed by drying using a freeze drier to obtain a toner particle (1).

—Preparation and Evaluation of a Developer (1)—

One part of colloidal silica (trade name: R972, manufactured by Nippon Aerosil Co., Ltd.) is added as an external additive to 100 parts of the resulting toner particles (1) and these components are mixed using a Henschel mixer to obtain an electrostatic image developing toner. 100 parts of ferrite particles (manufactured by Powdertech Co., volume average particle diameter: 50 μm) and one part of a methacrylate resin (manufactured by Mitsubishi Rayon Co., Ltd., molecular weight: 95,000) are poured together with 500 parts of toluene into a pressure kneader. These components are mixed at ambient temperature for 15 minutes and then raised to 70° C. with mixing under reduced pressure. After toluene is distilled, the mixture is cooled and subjected to grading by using a 105 μm screen to manufacture a ferrite carrier (resin coated carrier). This ferrite carrier is mixed with the above electrostatic image developing toner to manufacture a two-component type electrostatic image developer having a toner concentration of 7% by weight.

Using this electrostatic image developer, the charging characteristics, fixing characteristics and image quality characteristics of this developer are evaluated as follows. The results are shown in Tables 1 and 2.

—Charge Retaining Ability—

The charge retaining ability is evaluated by measuring the amount of initial charge and the amount of charge after the sample is allowed to stand in a circumstance of 80% relative humidity and 28° C. for one week by a blow-off charge amount measuring device (manufactured by Toshiba Chemical Co., Ltd.).

The standard of evaluation is as follows.

“G1”: Initial charge amount: 30 μC/g or more, and retaining ability of charge amount after one-week aging: 98% or more.

“G2”: Initial charge amount: 25 μC/g or more and less than 30 μC/g, and retaining ability of charge amount after one-week aging: 85% or more and less than 98%.

“G3”: Initial charge amount: less than 25 μC/g, and retaining ability of charge amount after one-week aging: less than 85%.

—Fixing Characteristics, Image Quality Characteristics—

The fixing characteristics and the image quality characteristics are evaluated in the following manner. Specifically, a remodeled machine of DocuCentre Color 500 CP manufactured by Fuji Xerox Co., Ltd. is used to form an image on J-paper manufactured by Fuji Xerox Co., Ltd. such that the amount of toner to be carried thereon is 10.5 g/m² and then, an external fixing device variable in fixing temperature is used to measure fixing temperature, thereby evaluating the quality of the initial image.

Here, the standard of evaluation of the fixing temperature is based on a difference between the cold-offset temperature (a phenomenon that because heat is insufficiently applied to the entire toner, the toner adheres to the heating surface) and the hot-offset temperature (a phenomenon that the entire toner is heated to decrease cohesive force, whereby the toner adheres to the heating surface), namely on the fixable temperature range.

“G1”: Fixable temperature range: 50° C. or more.

“G2”: Fixable temperature range: 30° C. or more and less than 50° C.

“G3”: Fixable temperature range is less than 30° C.

Also, with regard to the image quality characteristics, image quality uniformity (unevenness) and image strength are measured and a lower grade one is described in the table.

As to the image uniformity (unevenness), transfer unevenness caused by, for example, the charge distribution of toners particles because of a wide size distribution is observed visually.

The standard of evaluation is as follows.

“G1”: No transfer unevenness is visually observed.

“G2”: Though slight transfer unevenness is observed, there is no practical problem.

“G3”: Clear transfer unevenness is observed and there is therefore a practical problem.

Also, the image strength is evaluated according to a Pencil Scratching Tester Method of JIS K5400. Specifically, a test in which a fixed image is scratched by a pencil (trade name: UNI, manufactured by Mitsubishi Pencil Co., Ltd.) having a hardness of “H” under constant needle pressure at an angle of 45° to visually observe the presence of image scratches after scratched.

The standard of evaluation is as follows.

“G1”: No image scratch is observed and the image has sufficient image strength.

“G2”: The image has image strength having no practical problem, though slight image scratch is observed.

“G3”: Clear image scratches are observed and there is a practical problem in image strength.

### Example 2

—Preparation of a Polyester Resin (2)—

A three-neck flask is charged with 144.2 parts of cyclohexanedimethanol (Log(P)=0.9), 230.3 parts of 1,10-dodecanoic diacid (Log(P)=2.7) and 2 parts of scandium trifluoromethanesulfonate [Sc(OSO₂CF₃)₃] as a catalyst. Then, the atmosphere in the container is reduced by a vacuuming operation and is made inert by using nitrogen gas. Under this condition, the mixture is refluxed at 120° C. for 3 hours with mechanical stirring and is finally put in a viscous state. The molecular weight of the reaction solution is confirmed by GPC to find that the weight average molecular weight is 5,300. Also, the acid value of this resin is measured in the same manner as in Example 1, to find that it is 40 mgKOH/g. Thus, an oligomer of a polyhydric alcohol component and a polyvalent acid component is first formed in this manner.

156.1 parts of a styrene monomer (Log(P)=2.67), 39.1 parts of a butylacrylate monomer (Log(P)=1.88), 2 parts of hexadecane (Log(P)=7.18) and 2 parts of dodecanethiol (Log(P)=5.14) are mixed with this viscous liquid of 195 parts at 80° C. and the mixture is taken out at ambient temperature. This mixture is poured into 1377 parts of ion exchange water in which 11 parts of sodium dodecylbenzenesulfonate is dissolved. The solution is predispersed by ultrasonic wave and further emulsion-dispersed at 50° C. by using an extra-high pressure homogenizer (trade name: Nanomizer, manufactured by Yoshida Kikai Kogyo Co.), to obtain an emulsion having a volume average particle diameter of 0.3 μm. This emulsion is poured into a 3 L pressure type reactor equipped with a stirrer to run polymerization at 100° C. for 8 hours under a nitrogen atmosphere to obtain a resin microparticle dispersion solution (3). The reaction product retains a stable emulsion state and has a volume average particle diameter of 0.3 μm and a SD of 1.3.

The sample after the reaction is finished is taken out in a small amount to carry out the following various analysis in the same manner as in Example 1. The weight average molecular weight of the polymer is 21,000 and the polymerization yield of the radically polymerizable polymer by proton NMR is 2% or less. At this time, it is considered that all of the polymer components are almost polyesters. Further, the acid value of this polymer composition (polyester resin) is measured to find that the acid value is 15 mgKOH/g.

Further, the thermal characteristics of this resin are measured and as a result, the resin is found to be a crystalline resin having a melting point of 70° C.

—Polymerization of a Radically Polymerizable Monomer (2)—

3.9 parts of acrylic acid is added to the resin microparticle dispersion solution (3) obtained above and the mixture is allowed to stand at 80° C. for 1 hour with stirring to distribute the acrylic acid sufficiently into the particles. A solution obtained by dissolving 2.0 parts of ammonium persulfate in 10 parts of ion exchange water is added to the above resin solution and the mixture is polymerized again at 80° C. for further 5 hours in a nitrogen atmosphere to obtain a stable resin microparticle dispersion solution (4) having a volume average particle diameter of 0.3 μm and a SD of 1.3. After polymerized, a small amount of the sample is taken out to measure the polymerization ratio of the radically polymerizable monomer by NMR, to find that it is 99% or more. Moreover, the molecular weight of the resin microparticle dispersion solution (4) which is measured by GPC is 31,000 and the melting point of a crystalline polyester in the resin microparticles is 70° C.

—Production of a Toner Particle (2)—

A pigment dispersion solution and an ester wax dispersion solution are prepared in the same manner as in Example 1 except that the aforementioned resin microparticle dispersion (4) is used, then coagulated and heated to 95° C. to fuse these particles, thereby obtaining a final toner. The volume average particle diameter and volume average size distribution (GSDv) of the resulting toner are 5.5 μm and 1.23 respectively. This toner is a toner particle (2) having a potato shape.

—Preparation and Evaluation of a Developer (2)—

A developer (2) is prepared and the charging characteristics, fixing characteristics and image quality characteristics of the developer are evaluated in the same manner as in Example 1 except that the toner particle (2) is used. The results are shown in Tables 1 and 2. The developer in this example has the following characteristics: the initial charging characteristics of the developer is 35 μC/g or more, the ability of retaining the charging characteristics after the developer is aged is 99% or more. Also, the developer exhibits excellent image quality characteristics as to the fixing ability of the developer such that it has good fixing properties at 100° C. and a sufficient fixable temperature range.

### Example 3

—Polymerization of a Polyester Resin (3)—

A resin microparticle dispersion solution (5) is obtained by carrying out polymerization in the same manner as in Example 1 except that a mixture of 66 parts of terephthalic acid (Log(P)=1.15) and 23 parts of dodecanoic diacid (Log(P)=2.7) is used as a polyvalent carboxylic acid. The obtained resin microparticle has a particle diameter of 0.15 μm and a SD of 1.3. The polyester resin has a weight average molecular weight of 20,000, a melting point of 73° C. and an acid value of 8 mgKOH/g.

—Polymerization of a Radically Polymerizable Monomer (3)—

A resin microparticle dispersion solution (6) is obtained in the same manner as in the production of the resin microparticle dispersion solution (2) in Example 1 except that the resin microparticle dispersion solution (5) is used. The obtained resin microparticle dispersion solution (6) has a particle diameter of 0.15 μm and a SD of 1.3. The polymerization yield of the radically polymerizable monomer is 99% or more. The resin microparticle (6) has a weight average molecular weight of 25,000 and a melting point of 83° C.

—Production of a Toner Particle (3)—

A pigment dispersion solution and an ester wax dispersion solution are prepared in the same manner as in Example 1 except that the above resin microparticle dispersion solution (6) is used, then coagulated and heated to 95° C. to fuse the particles, thereby obtaining a final toner. The volume average particle diameter and volume average size distribution (GSDv) of the resulting toner are 5.0 μm and 1.25 respectively. This toner is a toner particle (3) having a spherical shape.

—Preparation and Evaluation of a Developer (3)—

A developer (3) is prepared and the charging characteristics, fixing characteristics and image quality characteristics of the developer are evaluated in the same manner as in Example 1 except that the toner particle (3) is used. The results are shown in Tables 1 and 2. The developer in this example has the following characteristics: the initial charging characteristics of the developer is 35 μC/g or more, the ability of retaining the charging characteristics after the developer is aged is 99% or more. Also, the developer exhibits excellent image quality characteristics as to the fixing ability of the developer such that it has good fixing properties at 100° C. and a sufficient fixable temperature range.

### Example 4

—Polymerization of a Polyester Resin (4)—

A resin microparticle dispersion solution (7) is obtained by carrying out polymerization in the same manner as in Example 1 except that 58.1 parts of fumaric acid (Log(P)=-0.36) as a polyvalent carboxylic acid and 179.2 parts of bisphenol A propylene oxide adduct (Log(P)=4.19) as a polyhydric alcohol are used. The obtained resin microparticle has a particle diameter of 0.25 μm and a SD of 1.3. The polyester resin has a weight average molecular weight of 12,000, a Tg (secondary glass transition temperature) of 63° C. and an acid value of 10 mgKOH/g.

—Polymerization of a Radically Polymerizable Monomer (4)—

A resin microparticle dispersion solution (8) is obtained in the same manner as in the production of the resin microparticle dispersion solution (4) in Example 1 except that the resin microparticle dispersion solution (7) is used. The obtained resin microparticle dispersion solution (8) has a particle diameter of 0.25 μm and a SD of 1.3. The polymerization yield of the radically polymerizable monomer is 99% or more. The resin microparticle (8) has a weight average molecular weight of 28,000 and a Tg of 58° C.

—Production of a Toner Particle (4)—

A pigment dispersion solution and an ester wax dispersion solution are prepared in the same manner as in Example 1 except that the above resin microparticle dispersion solution (8) is used, then coagulated and heated to 78° C. to fuse the particles, thereby obtaining a final toner. The volume average particle diameter and volume average size distribution (GSDv) of the resulting toner are 5.0 μm and 1.22 respectively. This toner is a toner particle (4) having a spherical shape.

—Preparation and Evaluation of a Developer (4)—

A developer (4) is prepared and the charging characteristics, fixing characteristics and image quality characteristics of the developer are evaluated in the same manner as in Example 1 except that the toner particle (4) is used. The results are shown in Tables 1 and 2. The developer in this example has the following characteristics: the initial charging characteristics of the developer is 35 μC/g or more, the ability of retaining the charging characteristics after the developer is aged is 99% or more. Also, the developer exhibits excellent image quality characteristics as to the fixing ability of the developer such that it has good fixing properties at 130° C. and a sufficient fixable temperature range.

### Example 5

—Polymerization of a Polyester Resin (5)—

A resin microparticle dispersion solution (9) is obtained by carrying out polymerization in the same manner as in Example 1 except that dodecylbenzenesulfonic acid is used in place of scandium trifluoromethanesulfonate as the polymerization catalyst and scandium trisdodecylsulfate is not used. The obtained resin microparticle has a particle diameter of 0.15 μm and a SD of 1.3. The polyester resin has a weight average molecular weight of 25,000, a Tg of 70° C. and an acid value of 8 mgKOH/g.

—Polymerization of a Radically Polymerizable Monomer (5)—

A resin microparticle dispersion solution (10) is obtained in the same manner as in the production of the resin microparticle dispersion solution (2) in Example 1 except that the resin microparticle dispersion solution (9) is used. The obtained resin microparticle dispersion solution (10) has a particle diameter of 0.15 μm and a SD of 1.3. The polymerization yield of the radically polymerizable monomer is 99% or more. The resin microparticle (10) has a weight average molecular weight of 28,000 and the melting point of the crystalline polyester in such resin microparticles is 69° C.

—Production of a Toner Particle (5)—

A pigment dispersion solution and an ester wax dispersion solution are prepared in the same manner as in Example 1 except that the above resin microparticle dispersion solution (10) is used, then coagulated and heated to 95° C. to fuse the particles, thereby obtaining a final toner. The volume average particle diameter and volume average size distribution (GSDv) of the resulting toner are 5.2 μm and 1.25 respectively. This toner is a toner particle (5) having a spherical shape.

—Preparation and Evaluation of a Developer (5)—

A developer (5) is prepared and the charging characteristics, fixing characteristics and image quality characteristics of the developer are evaluated in the same manner as in Example 1 except that the toner particle (5) is used. The results are shown in Tables 1 and 2. The developer in this example has the following characteristics: the initial charging characteristics of the developer is 35 μC/g or more, the ability of retaining the charging characteristics after the developer is aged is 99% or more. Also, the developer exhibits excellent image quality characteristics as to the fixing ability of the developer such that it has good fixing properties at 100° C. and a sufficient fixable temperature range.

### Example 6

—Polymerization of a Polyester Resin (6)—

A resin microparticle dispersion solution (11) is obtained by carrying out polymerization of a polyester in the same manner as in Example 4 except that 200 parts of methyl isobutyl ketone (Log(P)=1.6) is used in place of a styrene monomer, butylacrylate, dodecanethiol and hexadecane in Example 4. Moreover, this resin microparticles are heated to 85° C. under reduced pressure to remove methyl isobutyl ketone by distillation to obtain resin microparticles (12). The obtained resin microparticle has a particle diameter of 0.15 μm and a SD of 1.3. The polyester resin has a weight average molecular weight of 10,000, a Tg of 58° C. and an acid value of 12 mgKOH/g.

—Production of a toner Particle (6)—

A pigment dispersion solution and an ester wax dispersion solution are prepared in the same manner as in Example 1 except that the above resin microparticle dispersion solution (12) is used, then 1.0 part of sodium dodecylbenzenesulfonate is added to the mixture, which is then coagulated and heated to 95° C. to fuse the particles, thereby obtaining a final toner. The volume average particle diameter and volume average size distribution (GSDv) of the resulting toner are 5.0 μm and 1.22 respectively. This toner is a toner particle (6) having a spherical shape.

—Preparation and Evaluation of a Developer (6)—

A developer (6) is prepared and the charging characteristics, fixing characteristics and image quality characteristics of the developer are evaluated in the same manner as in Example 1 except that the toner particle (6) is used. The results are shown in Tables 1 and 2. The developer in this example has the following characteristics: the initial charging characteristics of the developer is 35 μC/g or more, the ability of retaining the charging characteristics after the developer is aged is 99% or more. Also, the developer exhibits excellent image quality characteristics as to the fixing ability of the developer such that it has good fixing properties at 130° C. and a sufficient fixable temperature range.

### Comparative Example 1

Dispersion of a polymer in an aqueous medium which polymer is directly polymerized from a polyester by conventional block polymerization, the production of a toner by this dispersing method and the characteristics of the toner are shown as a comparative example to prove that the polyester resin of the present invention has more excellent dispersion characteristics and the toner derived from the resin is superior in charging characteristics and image quality characteristics.

—Preparation of a Polyester Resin (7)—

A three-neck flask is charged with 230.3 parts of dodecanoic diacid (Log(P)=2.7), 160.0 parts of 1,9-nonanediol (Log(P)=1.86), and 2 parts of dibutyltin oxide as a catalyst. Then, the atmosphere in the container is reduced by a vacuuming operation and is made inert by using nitrogen gas. Under this condition, the mixture is refluxed at 180° C. for 12 hours with mechanical stirring and is finally put in a viscous state. The molecular weight of the reaction solution is confirmed by GPC to find that the weight average molecular weight is 28,000. Also, the acid value of this resin is measured in the same manner as in Example 1, to find that it is 5 mgKOH/g. The melting point of the resin is 70° C.

This resin is poured into 1377 parts of ion exchange water in which 11 parts of sodium dodecylbenzenesulfonate is dissolved. The solution is predispersed by a homogenizer (trade name: Ultraturrax T50, manufactured by IKA Company) and further emulsion-dispersed at 150° C. by using an extra-high pressure homogenizer (trade name: Nanomizer, manufactured by Yoshida Kikai Kogyo Co.). As a result, when the emulsion has a volume average particle diameter of 0.9 μm and a SD of 4.5, the emulsion particle diameter and size distribution are broad and reach to saturation and this dispersion solution cannot be made to have a smaller particle size and to have a narrower particle distribution. This resin dispersion solution is called a polyester resin microparticle dispersion solution (13).

—Production of a Toner Particle (7)—

A pigment dispersion solution and an ester wax dispersion solution are prepared in the same manner as in Example 1 except that the aforementioned resin microparticle dispersion (13) is used, then coagulated and heated to 95° C. to fuse these particles, thereby obtaining a final toner. The resulting toners are squarish toner particles which have a volume average particle diameter of 1.3 μm and a volume average size distribution (GSDv) of 1.5 and have a wide distribution range from 1 μm or less to 10 μm or more.

—Preparation and Evaluation of a Developer (7)—

A developer (7) is prepared and the charging characteristics, fixing characteristics and image quality characteristics of the developer are evaluated in the same manner as in Example 1 except that the toner particle (7) is used. The results are shown in Tables 1 and 2. The developer in this example has the following characteristics: the initial charging characteristics of the developer vary widely from 10 μC/g to 30 μC/g and the ability of retaining the charging characteristics after the developer is aged is 50% or less, posing a serious practical problem as to the reproducibility and retaining ability. Although the fixing temperature of this developer is 120° C., there are large image quality unevenness in the image quality characteristics of the developer and as to the image quality strength, fragile parts are present partly, posing a practically large problem.

### Comparative Example 2

—Polymerization of a Polyester Resin (8)—

In the polymerization of the polyester resin of Example (1), the hydrophobic materials including the styrene monomer, butylacrylate monomer, hexadecane and dodecanethiol are not used, but nonanediol and dodecanoic diacid are thoroughly mixed at 90° C. and 2.0 parts of scandium trifluoromethanesulfonate as a catalyst is dissolved rapidly in the mixture, which is then rapidly emulsified at 80° C. in the same manner as in Example 1 to obtain an emulsion having a volume average particle diameter of 0.5 μm, followed by polymerizing the polyester. The resin microparticles have a particle diameter of 0.55 μm and a SD of 1.3 and the polyester resin has a weight average molecular weight of 3,500 and an acid value of 55 mgKOH/g and this example fails to obtain a molecular weight enabling practical use.

### Comparative Example 3

—Polymerization of a Polyester Resin (9)—

In Example 1, an emulsification operation is carried out in the same manner as in Example 1 except that ethylene glycol (Log(P)=−0.79) is used in place of 1,9 nonanediol to obtain an emulsion having a volume average particle diameter of 0.23 μm. Then, the emulsion is subjected to polymerization performed in the same manner as in the polymerization of the polyester resin (1). The resin microparticles have a particle diameter of 0.25 μm and a SD of 1.3 and the polyester resin has a weight average molecular weight of 2,500 and an acid value of 56 mgKOH/g and this example fails to obtain a molecular weight enabling practical use.

TABLE 1

| | | Example 1 | Example 2 | Example 3 | Example 4 |
|---|---|---|---|---|---|
| Polyester | Polyvalent acid | Dodecanoic | Dodecanoic | Terephthalic acid (1.15) | Fumaric acid (−0.36) |
| particle | component | diacid (2.7) | diacid (2.7) | Dodecanoic diacid (2.7) | |
| dispersion | (Log(P)) | | | | |
| solution | Polyhydric alcohol | Nonanediol (1.86) | Cyclohexane | Nonanediol (1.86) | Bisphenol A propylene |
| | component | | dimethanol (0.9) | | oxide adduct (4.19) |
| | (Log (P)) | | | | |
| | \|Log(P)_{COOH} − | 0.84 | 1.80 | Difference between | 4.55 |
| | Log(P)_{OH}\| | | | terephthalic acid and a | |
| | | | | polyhydric alcohol | |
| | | | | component (0.71) | |
| | | | | Difference between | |
| | | | | dodecanoic diacid and a | |
| | | | | polyhydric alcohol | |
| | | | | component (0.84) | |
| | Hydrophobic | Styrene monomer (2.67) | Styrene monomer (2.67) | Styrene monomer (2.67) | Styrene monomer (2.67) |
| | material (Log (P)) | Butylacrylate | Butylacrylate | Butylacrylate monomer | Butylacrylate monomer |
| | | monomer (1.88) | monomer (1.88) | (1.88) | (1.88) |
| | | Dodecanethiol (5.14) | Dodecanethiol (5.14) | Dodecanethiol (5.14) | Dodecanethiol (5.14) |
| | | Hexadecane (7.18) | Hexadecane (7.18) | Hexadecane (7.18) | Hexadecane (7.18) |
| | Production of an | Not produced | Produced | Not produced | Not produced |
| | oligomer by the | | | | |
| | polymerization of | | | | |
| | the polyvalent acid | | | | |
| | component with the | | | | |
| | polyhydric alcohol | | | | |
| | before emulsified | | | | |
| | Catalyst | Sc(OSO₂CF₃)₃ | Sc(OSO₂CF₃)₃ | Sc(OSO₂CF₃)₃ | Sc(OSO₂CF₃)₃ |
| | | Scandium | | Scandium | Scandium |
| | | trisdodecylsulfate | | trisdodecylsulfate | trisdodecylsulfate |
| | Polyester resin, | 25,000 | 21,000 | 20,000 | 12,000 |
| | Weight average | | | | |
| | molecular weight | | | | |
| | Acid value (mgKOH/g) | 10 | 15 | 8 | 10 |
| | Volume average | 0.20 | 0.30 | 0.15 | 0.25 |
| | particle diameter | | | | |
| | (μm) | | | | |
| | SD value | 1.30 | 1.30 | 1.30 | 1.30 |
| Toner | Volume average | 6.0 | 5.5 | 5.0 | 5.0 |
| | particle diameter | | | | |
| | (μm) | | | | |
| | Volume average | 1.23 | 1.23 | 1.25 | 1.22 |
| | particle size | | | | |
| | distribution (GSDv) | | | | |
| | Charging | G1 | G1 | G1 | G1 |
| | characteristics | | | | |
| | Fixing temperature | G1 | G1 | G2 | G2 |
| | Image quality | G1 | G1 | G2 | G2 |
| | characteristics | | | | |

TABLE 2

| | | | | Comparative | | |
|---|---|---|---|---|---|---|
| | | Example 5 | Example 6 | Example 1 | Comparative Example 2 | Comparative Example 3 |
| Polyester | Polyvalent acid | Dodecanoic | Fumaric acid | Dodecanoic | Dodecanoic diacid (2.7) | Dodecanoic diacid (2.7) |
| particle | component | diacid (2.7) | (−0.36) | diacid | | |
| dispersion | (Log(P)) | | | (2.7) | | |
| solution | Polyhydric alcohol | Nonanediol (1.86) | Bisphenol A | Nonanediol | Nonanediol (1.86) | Ethylene glycol (−0.79) |
| | component | | propylene | (1.86) | | |
| | (Log(P)) | | oxide | | | |
| | | | adduct (4.19) | | | |
| | \|Log(P)_{COOH} − | 0.84 | 4.55 | (0.84) | (0.84) | 3.49 |
| | Log(P)_{OH}\| | | | | | |
| | Hydrophobic | Styrene | Methyl | None | None | styrene monomer (2.67) |
| | material (Log (P)) | monomer (2.67) | isobutyl | | | Butylacrylate monomer |
| | | Butylacrylate | ketone (1.6) | | | (1.88) |
| | | monomer (1.88) | | | | Dodecanethiol (5.14) |
| | | Dodecanethiol | | | | Hexadecane (7.18) |
| | | (5.14) | | | | |
| | | Hexadecane (7.18) | | | | |
| | Production of an | Not produced | Not produced | Produced | Not produced | Not produced |
| | oligomer by the | | | | | |
| | polymerization of | | | | | |
| | the polyvalent | | | | | |
| | acid component | | | | | |
| | with the | | | | | |
| | polyhydric alcohol | | | | | |
| | before emulsified | | | | | |
| | Catalyst | Dodecylbenzene- | Sc(OSO₂CF₃)₃ | Bu₂(OSn) | Sc(OSO₂CF₃)₃ | Sc(OSO₂CF₃)₃ |
| | | sulfonic | Scandium | | Scandium | Scandium |
| | | acid | trisdodecyl- | | trisdodecylsulfate | trisdodecylsulfate |
| | | | sulfate | | | |
| | Polyester resin, | 25,000 | 10,000 | 28,000 | 3,500(incomplete | 2,500(incomplete |
| | Weight average | | | | polymerization) | polymerization) |
| | molecular weight | | | | | |
| | Acid value (mgKOH/g) | 8 | 12 | 5 | 55 | 56 |
| | Volume average | 0.15 | 0.15 | 0.9 | 0.55 | 0.25 |
| | particle diameter | | | | | |
| | (μm) | | | | | |
| | SD value | 1.3 | 1.3 | 4.5 | 1.3 | 1.3 |
| Toner | Volume average | 5.2 | 5.0 | 1.3 | — | — |
| | particle diameter | | | | | |
| | (μm) | | | | | |
| | Volume average | 1.25 | 1.22 | 1.5 | — | — |
| | particle size | | | | | |
| | distribution (GSDv) | | | | | |
| | Charging | G1 | G1 | G3 | — | — |
| | characteristics | | | | | |
| | Fixing temperature | G1 | G2 | G3 | — | — |
| | Image quality | G1 | G2 | G3 | — | — |
| | characteristics | | | | | |

In Comparative Examples 2 and 3, the molecular weight required for a toner is not obtained so that no toner can be formed and therefore, the charging characteristics, fixing temperature and image quality characteristics of the toner cannot be evaluated.

It is understood from the above results that an increase in the molecular weight of the polyester can be attained since the highly hydrophobic polyester raw materials are polycondensed in the presence of the highly hydrophobic material (especially, a vinyl monomer) in this example. Also, the resulting microparticles are found to have good particle diameter and distribution. Then, the toner obtained utilizing these microparticles are found to be sufficiently satisfied in toner characteristics such as toughness (toner strength and image quality strength), distribution of particle diameter, charging characteristics and environmental dependency of charging. Also, the formation of an oligomer and the use of a radically polymerizable monomer are found to be very advantageous to attain an increase in molecular weight.

It is found that in, particularly, Examples 1, 2, 3 and 5 decreased in the value of |Log(P)_{COOH}−Log(P)_{OH}|, a high effect is obtained in view of the stoichiometric polymerizable characteristics of a monomer because the above hydrophobic parameter is smaller, and in the case of polymerizing in the same condition, a higher molecular weight can be obtained by a combination reduced in the above hydrophobic parameter.

It is found that in the comparative examples, on the other hand, it is difficult to increase the molecular weight of the polyester and very high energy is required even if a high molecular weight could be obtained. It is also found that the obtained resin microparticles (toner) are very large in size and inferior distribution of particle diameter.

It is understood that, as mentioned above, a method reduced in environmental load to produce a high quality polyester toner, which method has been expected to be improved in view of production and environmental load (energy) is established in the method of polymerizing a polyester in an aqueous medium. Particularly in the case of crystalline polyester resins important in low-energy electrophotographic technologies such as low-temperature fixing ability which becomes more important from now on, it is difficult to attain an reduction in particle diameter which reduction is most important to attain high quality characteristics. In order to attain the reduction in particle diameter, production processes, requiring a large energy load and using organic solvents which are not considered to be environmentally desirable have been used. It is understood that a solution to the problem is found, making highly compatible the production of a high performance polyester resin toner and a low-environmental load production method.

Therefore, in the invention, the production of a high performance polyester resin toner and a low-environmental load production method are both attained in a highly compatible manner and an electrophotographic toner which is produced under a low environmental load by using a lower energy and which can be applied to a high-image quality and low-energy process and is highly reliable can be obtained.

What is claimed is:

1. A method of producing a polyester, the method comprising:
emulsifying or dispersing a polyvalent acid component having a hydrophobic parameter (Log(P)) of −0.5 or more and 20 or less, a polyhydric alcohol component having a hydrophobic parameter (Log(P)) of −0.5 or more and 20 or less, and a hydrophobic material having a hydrophobic parameter (Log(P)) of −0.5 or more and 20 or less in an aqueous medium; and
polycondensing the polyvalent acid component with the polyhydric alcohol component in the presence of the hydrophobic material.

2. The method of producing the polyester according to claim 1, wherein the hydrophobic material is a radically polymerizable monomer.

3. The method of producing the polyester according to claim 2, wherein the radically polymerizable monomer is a vinyl monomer.

4. The method of producing the polyester according to claim 2, further comprising polymerizing the radically polymerizable monomer.

5. The method of producing the polyester according to claim 1, wherein the absolute value (|Log(P)_{COOH}−Log(P)_{OH}|) of the difference between the hydrophobic parameter (Log(P)_{COOH}) of the polyvalent acid component and the hydrophobic parameter (Log(P)_{OH}) of the polyhydric alcohol component is in the range of from 0 to 5.0.

6. The method of producing the polyester according to claim 1, wherein a part or all of the polyvalent acid component and of the polyhydric alcohol component is an oligomer.

7. The method of producing the polyester according to claim 6, wherein the oligomer has a weight average molecular weight of 3,000 or less.

8. The method of producing the polyester according to claim 1, further comprising adding a radically polymerizable monomer to the aqueous medium.

9. The method of producing the polyester according to claim 8, wherein the radically polymerizable monomer is selected from the group consisting of an aromatic vinyl monomer, a (meth)acrylate monomer, a vinyl ester monomer, a vinyl ether monomer, a monoolefin monomer, a diolefin monomer, and a halogenated olefin monomer.

10. The method of producing the polyester according to claim 8, wherein the radically polymerizable monomer is an acidic vinyl monomer.

11. The method of producing the polyester according to claim 1, wherein at least one catalyst selected from a Brønsted catalyst and an enzyme catalyst is used in the polycondensation.

12. The method of producing the polyester according to claim 11, wherein the Brønsted catalyst is a rare earth element catalyst containing a rare earth element selected from Y, Sc, Yb, and Sm.

13. The method of producing the polyester according to claim 11, wherein the Brønsted catalyst is a dodecylbenzenesulfonic acid.

14. The method of producing the polyester according to claim 11, wherein the catalyst has surfactant activity.

15. The method of producing the polyester according to claim 1, wherein the polyvalent acid component and the polyhydric alcohol component are components used to obtain a crystalline polyester.

16. The method of producing the polyester according to claim 1, wherein the polyvalent acid component is selected from the group consisting of adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, phthalic acid, isophthalic acid, terephthalic acid, naphthalene-2,6-dicarboxylic acid, 1,2,4benzenetricarboxylic acid, 1,2,5-benzenetricarboxylic acid, 1,2,4-naphthalenetricarbixylic acid, maleic acid, and fumaric acid, and anhydrides or lower alkyl esters of these acids, and the polyhydric alcohol component is selected from the group consisting of 1,4-butanediol, 1,5-pentanediol, 1,6-hexanediol, 1,4-cyclohexanediol, 1,4-cyclohexanedimethanol, 1,7-heptanediol, 1,8-octanediol, 1,9-nonanediol, 1,10-decanediol, 1,11-undecabediol, 1,12-dodecanediol, 1,13-tridecanediol, 1,14-tetradecanediol, 1,18-octadecanediol, 1,14-eicosadecanediol, trimethylolpropane, ethylene oxide adducts of bisphenol A, and propylene oxide adducts of bisphenol A.

17. The method of producing the polyester according to claim 1, wherein the polyester has an acid value of 0.5 mgKOH/g or more and 40 mgKOH/g or less.

18. A method of producing an electrostatic developing toner, the method comprising:
emulsifying or dispersing a polyvalent acid component having a hydrophobic parameter (Log(P)) of −0.5 or more and 20 or less, a polyhydric alcohol component having a hydrophobic parameter (Log(P)) of −0.5 or more and 20 or less, and a hydrophobic material having a hydrophobic parameter (Log(P)) of −0.5 or more and 20 or less in an aqueous medium;
polycondensing the polyvalent acid component with the polyhydric alcohol component in the presence of the hydrophobic material to obtain a polyester resin particle dispersion solution;
coagulating the resin particles in a dispersion solution in which at least the resin particles are dispersed to obtain coagulated particles; and
fusing the coagulated particles by heating.

19. The method of producing the electrostatic developing toner according to claim 18, wherein the hydrophobic material is a radically polymerizable monomer.

20. The method of producing the electrostatic developing toner according to claim 19, wherein the radically polymerizable monomer is a vinyl monomer.

21. The method of producing the electrostatic developing toner according to claim 19, the method further comprising polymerizing the radically polymerizable monomer at the same time or after the polyvalent acid component is polycondensed with the polyhydric alcohol component.

22. An electrostatic developing toner comprising at least a colorant and a resin, wherein the resin contains a polyester resin obtained by emulsifying or dispersing a polyvalent acid component having a hydrophobic parameter (Log(P)) of −0.5 or more and 20 or less, a polyhydric alcohol component having a hydrophobic parameter (Log(P)) of −0.5 or more and 20 or less, and a hydrophobic material having a hydrophobic parameter (Log(P)) of −0.5 or more and 20 or less in an aqueous medium, and polycondensing the polyvalent acid component with the polyhydric alcohol component in the presence of the hydrophobic material.

23. The electrostatic developing toner according to claim 22, wherein the hydrophobic material is a radically polymerizable monomer.

24. The electrostatic developing toner according to claim 22, wherein the radically polymerizable monomer is a vinyl monomer.
